(19) United States
(12) Patent Application Publication
(10) Pub. No.: US 2012/0043411 A1
(43) Pub. Date: Feb. 23, 2012

(54) UNMANNED AERIAL VEHICLE SYSTEM

(75) Inventors: Peter Joseph Beck, Parnell (NZ); Nikhil Raghu, Auckland (NZ)

(73) Assignee: L2 Aerospace, Frederick, CO (US)

(21) Appl. No.: 13/149,576

(22) Filed: May 31, 2011

Related U.S. Application Data
(60) Provisional application No. 61/350,203, filed on Jun. 1, 2010.

(51) Int. Cl. F42B 15/08; F42B 10/14; H04N 7/18; B64D 17/80

(52) U.S. Cl. 244/3.24; 244/3.27; 102/374; 348/144; 348/E07.085

(57) ABSTRACT

A UAV includes: a rocket body, having a rocket motor and a payload section; a parachute coupled with the payload section; an image capture device; a magnetometer to provide a compass reference for images taken from the image capture device; and a transmitter to communicate image and compass data to a remote receiver. Compass bearings are overlaid on image data from the image capture device. A handheld launch unit includes an ignition system, having an activation mechanism and an igniter to activate the rocket motor. A safety pin prevents electrical current from flowing to the igniter until the pin is removed. An accelerometer and/or magnetometer determines an angular orientation of the UAV. Software verifies that the angle is within a user-defined safety limit before activating the igniter.

### CROSS-REFERENCE TO RELATED PATENT APPLICATIONS

The invention claims priority from U.S. Provisional Patent Application No. 61/350,203 entitled UNMANNED AERIAL VEHICLE SYSTEM by Peter Joseph Beck and Nikhil Raghu, filed on Jun. 1, 2010, which Provisional Patent Application is hereby incorporated by reference in its entirety.

### BACKGROUND

Unmanned aerial systems are used in civil and military applications to gain situational awareness. Existing and proposed situational awareness solutions are generally complicated and include UAV's that are expensive, require large amounts of training, and are slow to respond, with some requiring the troop to become a pilot whilst in a high-pressure situation confronting other threats.

In one example, fixed-wing, military UAV systems currently in use include the Reaper and Predator drones, which may, in many missions, be replaced in the near future by the MQ-X. These systems provide high performance surveillance, attack options (including the use of cannon, bomb, and missile payloads), as well as cargo capacities. However, such systems are large, costly, and complex. They require significant real estate, having a runway and storage facilities. Accordingly, such systems are not practical for military or civilian use in the field on a moments notice. They cannot be carried easily into hostile environments by light infantry or hazardous duty personnel. Such applications require systems that are easily carried, with additional equipment, by individuals in life-threatening environments. This requires relatively small sizes and light weights. Just as important, however, such applications require that the user be able to focus on the user's environment and concentrate on potential threats. Traditional fixed-wing UAVs are controlled remotely from the environments in which they patrol. They require all of their pilots' attention to successfully complete complex mission sorties.

Other examples of surveillance UAVs include various one-use shells, launched much like a mortar. Such systems can include cameras that transmit images to remote receivers. They are also relatively inexpensive due to their simple construction and non-reusable design. However, these designs also have several shortcomings that prevent them from fulfilling all of the needs in the technology. For example, the manner in which the shells travel along their flight path is very quick. Any equipment that is used to capture images must work quickly to gather fleeting images of a surrounding environment. The manner in which they are launched is dangerous, too. There are no safeties in such systems that prevent a user from shooting the device at an angle that risks harm to adjacent personnel or property. It is conceivable that a user could, for example, discharge the shell into the user's own foot. Finally, such systems typically require a rotational movement to all or part of the shell to provide flight path stability. Payload portions of such shells must be stabilized against the rotation of the shell in order to provide quality imagery. Such systems add complexity and expense to such systems and cannot be guaranteed to accurately stabilize both the shell and the image capture systems on board.

Still other examples of prior surveillance, UAVs include relatively complex control surfaces and systems to “pilot” a payload section through a planned trajectory. Such systems add to the cost and complexity of a system and reduce the systems reliability over time. Just as problematic, however, is the fact that they require the user to be a pilot in hostile environments, which is not practical. As such control surfaces and systems are added to UAVs, they move further away from being practically expendable due to their cost. Moreover, such systems require extensive training to pilot the systems, similar to the training provided for fixed-wing systems. Despite their complexity and sophistication, however, such systems remain unduly dangerous in the field because they lack systems for preventing a launch of the system at dangerous or otherwise ineffective angles.

Irrespective of the platform previously used for surveillance UAVs, none of the systems provide quick imagery of neighboring environments, in an easy to use format, that accurately overlays obtained images with directional data. Certainly, hostile environments can provide instances with unfamiliar or obscured landmarks. Images that provide feedback on who or what is near or approaching a user of the UAV are useless if they do not tell the user where the subject of the images is located. Most compact, portable systems do not provide any such feedback. However, none provide information as to the location of the subject of the images, relative to the UAV or the user. Similarly, such systems do not provide feedback as to the position and altitude of the UAV when the images were taken.

Surveillance UAVs have been provided in reusable and single-use formats. However, not all UAVs are recovered, even if they were intended to be recovered. Accordingly, UAVs lost in hostile environments pose a number of security risks. Certainly, imagery and positioning data obtained by a UAV is sensitive to the extent it gives away the intended purpose or future plans of the user. Technology and data native to the UAV is also sensitive and should be guarded from falling into the hands of unauthorized personnel. Accordingly, surveillance UAVs of the prior art that do not provide self destruct systems create potential security risks for their users. It is important, however, that such self destruct systems not only be thorough but timed properly so as to not interrupt the mission with a premature destruction of the UAV, which would only be a slim improvement to the UAV self-destructing after falling into unauthorized hands.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In at least one aspect, the present technology invention may broadly be said to consist of an unmanned aerial vehicle (UAV) that, in various embodiments, includes: a rocket body, having a rocket motor and a payload section; a parachute within the body that is coupled with the payload section of the rocket body and configured to regulate a descent of the payload section; an image capture device in the payload section that is configured to provide one or more aerial images; a magnetometer in the payload section that is configured to provide a compass reference for the one or more images taken from the image capture device; and a radio transmitter in the payload section that is configured to communicate image and magnetometer data to a ground station receiver. In various embodiments, the payload section is separable from the motor during flight.

In various embodiments, the image capture device is located at a nosecone portion of the payload section and provides images of the environment during descent of the payload section. Some embodiments include an optically clear nosecone at an end of the payload section, adjacent to the image capture device, which allows one or more aerial images of the area beneath the nosecone to be taken while the payload section descends. In some embodiments, the image capture device may be provided to take still images or video. Alternatively, or in addition, the image capture device may include other sensors used for gaining situational awareness, such as infrared sensors, synthetic aperture radar, or the like.

Various embodiments of the vehicle further includes a processor in the payload section that controls operation of the image capture device or other equipment that may include a magnetometer, radio transmitter, or the like. Some embodiments of the vehicle payload section include equipment that provides data indicative of location, such as latitude and longitude, altitude and/or attitude of the vehicle. This equipment may be one or more various combinations of a GPS antenna and receiver, one or more barometers, and one or more inertial measurement units, such as a unit comprising accelerometers and/or gyroscopes. The data can be transmitted to a ground station receiver via the radio transmitter.

Various embodiments of the vehicle include one or more fins that are positioned adjacent a rear portion of the body for aerodynamic stability during flight. The fins may be retractable toward or within the body for storing the vehicle. In at least one embodiment, the fins may be foldable, flip out fins. Alternatively, the fins may be detachable from the body.

Embodiments of the UAV may further include a self-destruct system, which may be activated at a pre-determined time after launching the vehicle, such as when the payload section comes to rest. The self-destruct system may include a software erase system that is arranged to command all data and programming carried by the payload section to be erased on activation of the system and/or a mechanical hardware destruction system including a pyrotechnic device, for instance, arranged to physically damage hardware carried by the payload section on activation of the system.

In another aspect of the present technology, the system includes: a UAV; a launch unit for receiving the UAV; an ignition system that activates the rocket motor and launches the UAV from the launch unit; and a ground station having a receiver that receives data from a radio transmitter associated with the UAV.

In various embodiments, the launch unit includes a handheld launch tube. In some embodiments, the handheld launch tube is provided with a length of less than 24 inches and a diameter of less than or equal to 2 inches. The launch tube may also serve as a storage unit for the UAV. In some embodiments, the launch tube may incorporate a blast cover to protect the operator during launch. It is contemplated that various embodiments of the blast cover may be collapsible and/or flexible.

The ground station may be provided as a portable ground unit. In various embodiments, the ground unit includes an onboard processor that manipulates and processes images and data received from the UAV. The ground unit may include one or more various systems for transferring the data to one or more user devices. The user device, in various embodiments, may be an LCD display, a handheld PDA or a cellular phone, for example. Any processors in the UAV, ground station unit, or other user devices may use the data from one or more magnetometers to overlay a compass bearing over an image received from the image capture device.

The ignition system of the present technology may, in various embodiments, include: a processor that controls operation of the system; an activation mechanism for initiating a timer; and a pyrotechnic igniter that is configured to activate a rocket motor within the vehicle after a pre-determined amount time.

The activation mechanism may be provided as a pin within the UAV that projects outside the vehicle body so that it may be pulled by a user. In such embodiments, the pin prevents electrical current from flowing to the igniter until the pin is removed. In some embodiments, the ignition system further includes an accelerometer and/or magnetometer that determines the angle of the UAV, wherein the processor is arranged to verify that the angle is within a user-defined safety limit before activating the pyrotechnic igniter. In some embodiments, audio or visual systems are provided that enable a user to find an optimum launch angle. The optimum launch angle may be determined by pre-programmed or calculated trajectory angles for launch that depend on the desired location and altitude of the UAV for capturing aerial images of a particular area of interest.

In another aspect of the present technology, a method for providing frames of reference for aerial reconnaissance images includes: receiving image data indicative of one or more images captured from a UAV; receiving magnetometer data associated with the images; and referencing compass bearings to each image using the magnetometer data to determine the orientation of the image capture device of the UAV with respect to magnetic north. The method may further include referencing distance in an image using pre-determined scales dependent on altitude data. The method may further include referencing GPS co-ordinates to any point in an image. In some embodiments, location grid-boxes may be laid over an image to associate GPS co-ordinates with the image.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the UAV of the present technology.

FIG. 2 depicts a perspective, cut-away view of the UAV of FIG. 1.

FIG. 3 depicts one embodiment of the UAV of FIG. 1 during descent after deployment of a parachute.

FIG. 4 depicts a perspective view of one embodiment of a receiver unit that may be associated with the UAV of the present technology.

FIG. 5 depicts a perspective, cut-away view of one embodiment of a UAV of the present technology as it may be positioned within a storage/launch tube of the present technology.

FIG. 6 depicts a perspective view of one embodiment of the storage/launch tube of the present technology as it may be held by a user.

FIG. 7 depicts a flow diagram of one embodiment of operating a UAV of the present technology.

FIG. 8 depicts a schematic of one embodiment of the electronics and avionics equipment associated with an embodiment of the UAV of the present technology.

FIG. 9 depicts an exemplary embodiment of how image and positioning data may be presented to a user of a remote receiver associated with one embodiment of the UAV of the present technology.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

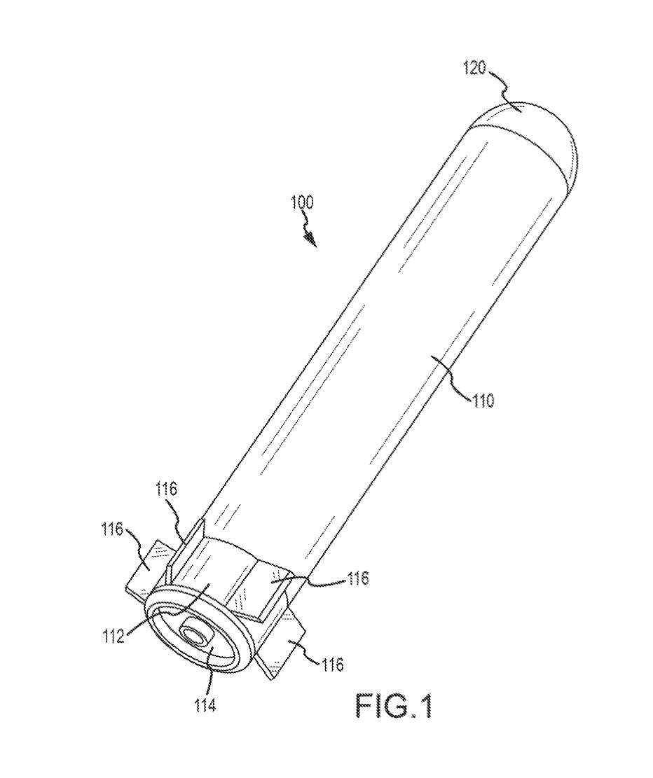

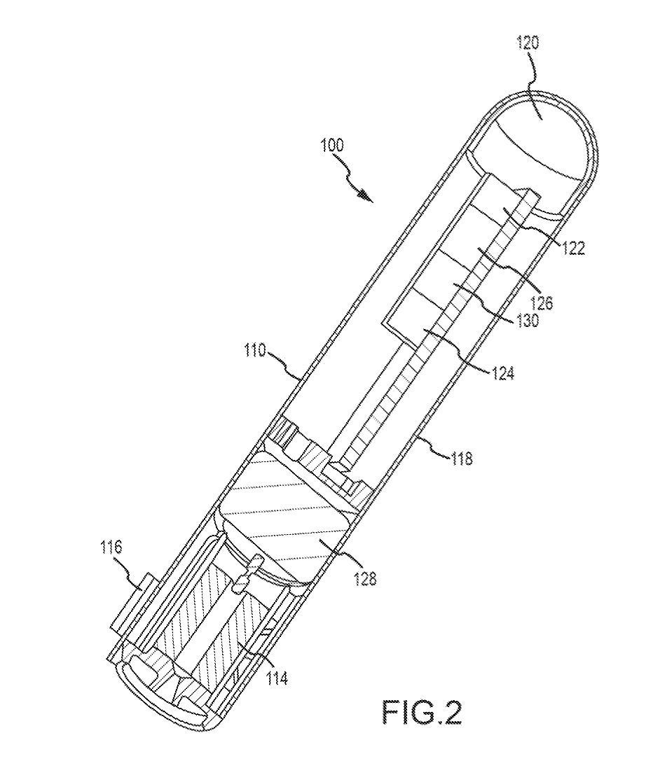

With reference to FIGS. 1 and 2, an embodiment of an unmanned aerial vehicle (UAV) 100 is shown as a sub-orbital rocket having a generally tube-shaped rocket body 110. A propulsion section 112 is positioned at a rearward end portion of the rocket body 110 and houses a rocket motor 114, which provides the UAV 100 with the necessary thrust for flight. Fins 116 are positioned to project from the rearward end portion of the rocket body 110, such as from the propulsion section 112. The fins 116 arc shaped in a manner that will be recognized by those of skill in the art as providing the UAV 100 with aerodynamic stability during flight, without unduly adding weight or profile to the UAV 100. The rocket body 110 further includes a payload section 118 at a forward end portion of the rocket body. A nosecone 120 is positioned at a forward end portion of the payload section 118. In some embodiments, the nosecone 120 is provided at a forward end portion of the rocket body 110. In this manner, a clear image path may be provided for an image sensor/image capture device 122 positioned within the payload section 118, adjacent or inside the nosecone 120.

In various embodiments, the UAV 100 contains a payload of surveillance equipment mounted within the payload section 118, adjacent the nosecone 120. For example, with reference to FIG. 2, a payload section 118 may be provided in one of various designs to store and maintain a payload of one or more surveillance or guidance instruments throughout a useful lifespan of the UAV 100. The image capturing device 122 may provide still or moving video imagery, high resolution still imaging (CCD), thermographic imagery and/or comprise any other sensors used for gaining situational awareness, such as infrared sensors (i.e. adapted to capture images at a certain wavelength for night vision, for example) or synthetic aperture radar. The UAV 100 also includes a computing device 124 in the payload section 118 to control the operation of and receive data from the surveillance equipment such as the image capture device 122. The operation of the computing device 124, as it relates to the surveillance equipment and other components associated with the UAV 100, is described in greater detail below.

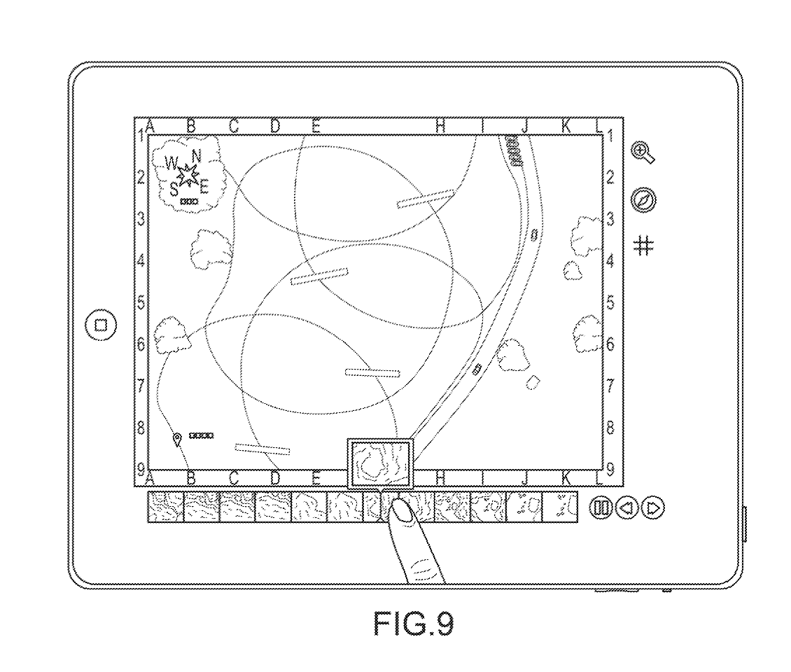

In various embodiments, the payload section 118 of the UAV 100 carries positioning/locating equipment 126 that is able to provide data relative to the position of the UAV during its use. For example, in some embodiments, one or more magnetometers may provide compass reference data relative to magnetic north during descent of the payload section 118. This allows the orientation of the device to be determined with respect to magnetic north, enabling compass bearings to be laid over the images captured from the image capture device 122. FIG. 9 depicts an exemplary, embodiment of how image and positioning data may be presented to a user of a remote receiver associated with one embodiment of the UAV 100 of the present technology. In some embodiments, other equipment that may be present in the payload section 118 of the UAV 100 for providing data indicative of position/location such as latitude and longitude, altitude and/or attitude of the vehicle. It is contemplated that positioning/locating equipment 126 may be any combination of a GPS antenna and receiver, one or more barometers, and one or more inertial measurement units, such as a unit comprising accelerometers and/or gyroscopes. The readings from the positioning/locating equipment 126 are recorded at the time of image capture, allowing for further contextual relevance to the image. For instance, the barometer and/or accelerometer will be used to determine the altitude the image was taken from. The magnetometer allows the determination of magnetic north and the GPS receiver provides location of the UAV 100 at the time the picture was taken. In still other embodiments, other onboard sensors and equipment may be provided within the payload section 118 to provide further useful information to the user. The positioning/locating equipment 126 and other sensors and equipment will, as with the surveillance equipment, be electrically associated with the computing device 124, which will control, coordinate, and monitor, the positioning/locating equipment 126 and other equipment.

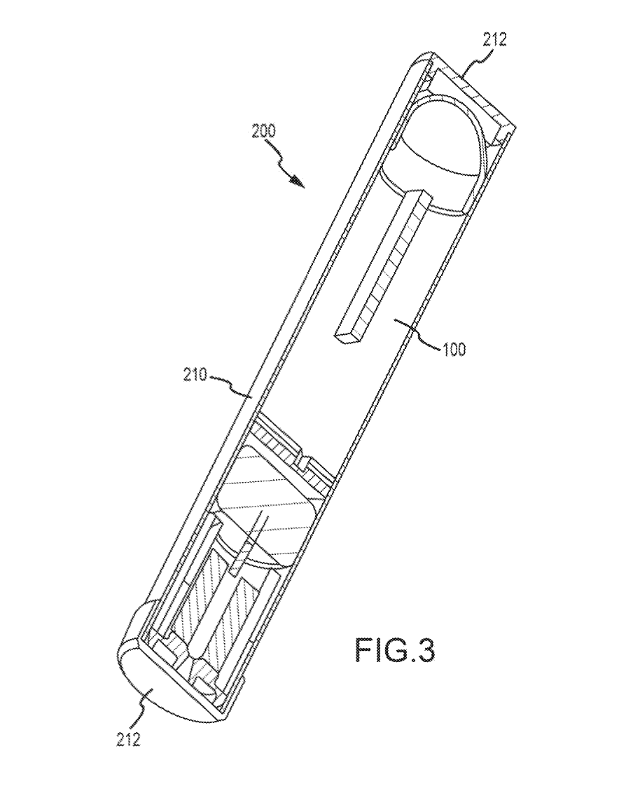

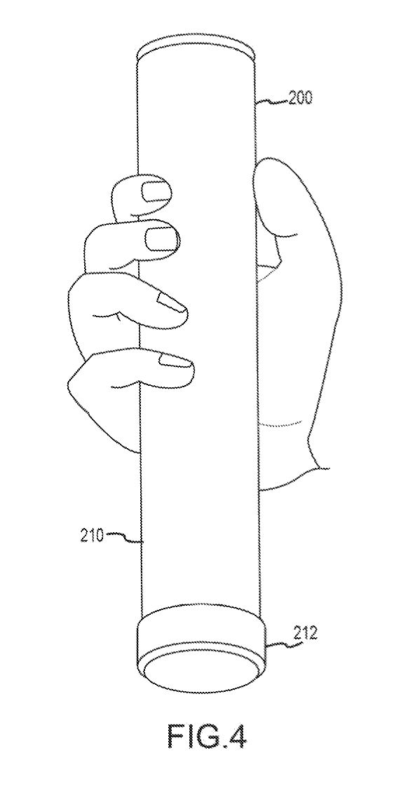

With reference to FIGS. 3 and 4, the UAV 100 is stored within and launched from a launch unit 200. The launch unit 200, in various embodiments, includes a launch tube 210 for receiving the rocket body 110 (which, in the preferred form, also doubles as the storage tube for the UAV 100 as shown in FIG. 3) and a launch rail for the launch tube 210. Removable end caps 212 enclose the opposite ends of the launch tube 210. In various embodiments, the launch unit 200 is provided as a handheld system, such as depicted in FIG. 4. In some embodiments, the handheld launch tube 200 has a length of less than or equal to 24 inches and a diameter of less than or equal to 2 inches. In some embodiments, the launch tube 210 may incorporate a blast cover to protect the operator during launch. The blast cover may be collapsible and/or flexible.

The launch unit 200 uses an ignition system associated with the rocket motor 114 to attain an aerial surveillance path. The rocket motor 114 is provided with performance parameters that deliver the UAV 100 to apogee as rapidly as possible, within the acceleration and force constraints of all the systems onboard. In some embodiments, the rocket motor 114 is also designed to have a short burn-time to ensure tracking or identification of the launch source is not easily determined. For example, the rocket motor 114 may use a propellant, such as low smoke composite, which may provide a burn time of less than one second and generate low amounts of visual exhaust. In some embodiments, a separation system separates the propulsion section 112 from the payload section 118 at a predetermined time or at a certain altitude after launch. In such embodiments, the rocket body 110 is effectively divided into at least two component parts; a propulsion section 112 that includes the rocket motor 114 and the payload section 118. The two component parts can be secured to one another in a variety of methods known to those of skill in the art. For example, opposing collar and socket structures associated with the component parts may be secured to one another in a friction-fit manner or with one of various low-bond adhesives or other mechanical fasteners. As those of skill in the art will appreciate, some embodiments of the separation system include within the rocket motor 114 a separation charge at a terminal end of a propellant charge. The separation charge will be provided in an amount sufficient to separate the propulsion section 112 aspect of the rocket body 110 from the payload section 118 aspect. Other embodiments include a separate electronically controlled separation system. In such embodiments, software associated with the computing device 124 will send a signal, timed relative to a preplanned position along the flight path of the UAV 100, to a separation charge located adjacent a coupling point between the propulsion section 112 and the payload section 118, which will generate a sufficient charge of gas to separate the structures. In another embodiment, the propulsion section 112 may not separate from the payload after launch.

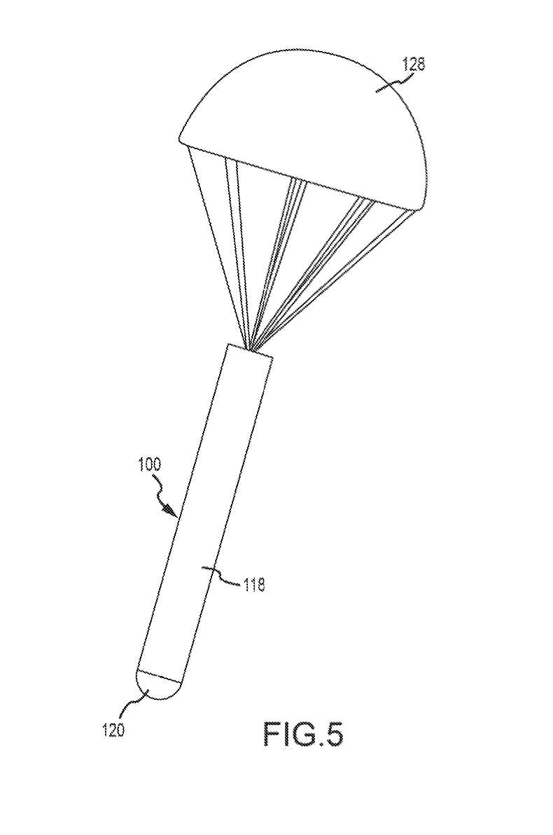

With reference to FIG. 5, the UAV 100 includes a descent control system. In various embodiments, the descent control system includes a parachute 128 stored within the rocket body 110 that automatically deploys at or near an apogee of the flight path of the UAV 100 to regulate descent of the payload section of the body 110. In various embodiments, the parachute 128 will deploy from a rearward portion of the payload section 118, or rocket body 110, where the rocket motor 112 is not separated from the UAV 100. In various embodiments, the parachute 128 is a cross parachute, which will provide good stability to the payload section 118 as images are being captured. In some embodiments, the parachute 128 and the payload section will be designed to provide a nominal descent rate of approximately ten meters per second. As depicted in FIG. 5, the position of the parachute 128 at or near the rearward end of the UAV 100 will orient the nosecone 120 in a downward facing position so that it is aimed at the ground. Throughout the descent of the payload section 118, the image capture device 122 within the payload section 118 captures images of the ground from altitude, which may be transmitted to a remote receiver simultaneously or at a desired point during the flight.

After capturing the desirable data (such as the combination of image and magnetometer data) from the payload equipment, the UAV 100 broadcasts the data using onboard transmitting equipment, such as a radio transmitter 130 (or any other suitable transmission mechanism), that is electrically associated with the computing device 124. In various aspects of the present technology, minimal processing is done on board the UAV 100 to eliminate complication in hardware and software on the expendable UAV unit 100. In some embodiments, the radio transmitter 130 is also contained within the payload section and preferably operates on IEEE802.11 wireless standard where any device, such as a laptop, FDA or iPhone, with the capability to communicate on this standard shall be able to receive and interpret images and other data from the UAV 100. Any other feasible radio transmission standard may be used by the system in alternative embodiments. Information and data transmitted by the transmitting equipment can include computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, contemplated transmission media includes various wireless media such as acoustic, RF, infrared, or other wireless media.

In various embodiments, operation of the computing device 124 with the various sensors and equipment associated with the UAV 100 may be described in the general context of computer-executable instructions, such as program modules, being executed by the computing device 124. Generally, program modules include routines, programs, objects, components, data structures, etc. that perform particular tasks or implement particular abstract data types. In a basic configuration, computing device 124 includes at least one processing unit and system memory. Depending on the exact configuration and type of computing device 124, system memory may be volatile (such as RAM), non-volatile (such as ROM, flash memory, and the like) or some combination of the two. The system memory typically includes at least one or more application programs and may include program data.

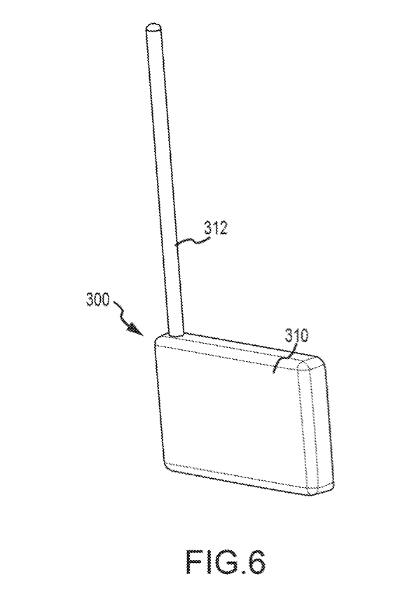

The computing device 124, through operation of the transmitting equipment, may relay data and other information to one or more remote devices, such as a ground station receiving unit 300. For purposes of simplicity, the receiving unit 300 is depicted in FIG. 6 as including at least a body portion 310, capable of displaying data received from the UAV 100, and an antenna 312 for receiving the transmitted data. Another exemplary embodiment of the receiving unit 300 is depicted in FIG. 9. In some embodiments, the receiving unit 300 is provided to receive the transmitted UAV data, decrypt the data (if encrypted by the UAV prior to transmission), process the data in any other manner and relay the information to a number of user devices, visualization equipment, such as dedicated LCD displays, PDA or cell phone type devices and/or other ground receiver units. The receiving unit 300 may be operated by an individual who launched the UAV 100 or another individual who is remotely positioned from the individual who launched the UAV 100. It is contemplated that the receiving unit 300 may take the form of a personal computer, a server, a router, a network PC, PDA, a peer device, or other common network node and, typically, includes many or all of the elements described above relative to the computing device 124. It is further contemplated, however, that the receiving unit 300 could be provided in the form of a telephone, which includes cellular telephones, landline telephones and the like. Accordingly, the UAV data can be transmitted directly to various user devices for image viewing and manipulation.

In various embodiments, the display unit, whether it be on the ground station receiving unit 300 or another remote user device, includes software functionality to allow the user to easily zoom in on various elements of the captured images. Updated information from a closer range can be constantly received by the display unit as new images are obtained during the UAV's descent. The visual display unit may have touch screen functionality or other means of user interface and control such as keypads or mouse/joystick-type devices coupled thereto.

In the preferred embodiment, the ground station receiving unit 300 or display unit/user device uses the magnetometer data from the UAV 100 to overlay compass markings over the image data from the UAV 100 and orient the image to north on the display. Furthermore, software functionality within the ground station receiving unit 300 can use the GPS location of the UAV, together with the attitude and altitude of the UAV, to determine exactly what location the image was captured in and to overlay a co-ordinate system (latitude and longitude) on the imagery. The user can then easily extract GPS co-ordinates of any selected point in the image through the visual display. In an alternative embodiment, the overlaying of compass markings and/or co-ordinate systems may be done by the computing device 124 prior to transmission to the ground station receiving unit 300 and the ground station receiving unit 300 may simply display the image with the overlaid information and/or relay it to other visual devices.

The UAV's 100 ascent may be unguided with aerodynamic stability maintained through fins 140 positioned at the rear of the UAV. Any suitable number and shape of fins 140 may be used and they can be designed or assembled such that a spin is imparted on the UAV during its ascent to passively stabilize the UAV. Storable volume of the UAV may be decreased by designing the fins to fold, retract, or otherwise collapse or detach and flip out, or with a necked-down rear section of the rocket body which allows for fixed fins to be used. This allows the overall stored diameter of the UAV 100 to be nearly the same as a rocket body 110 and minimize the overall size of the launch unit 200 and, specifically, the launch tube 210.

In some embodiments launch hardware is provided to allow the UAV 100 to be safely pointed toward its intended location and launched. This will guide the UAV 100 during initial engine firing when speed and, therefore, aerodynamic stability is insufficient to ensure accurate trajectory of the UAV 100.

An ignition system is provided for activating the rocket motor 114 and launching the UAV 100 out of the launch unit 200. In various embodiments, the ignition system includes a processor for controlling operation of the system, an activation switch for initiating a timer (which can be coded as software on the processor), and a pyrotechnic igniter to be activated by the processor after a pre-determined time upon initiation of the timer to thereby activate the rocket motor 30. The processor may be onboard the UAV 100 and separate from or integrated with the computing device 124. The ignition system may provide a safety system that ensures that the rocket motor 114 cannot be accidentally ignited through electrical current passing to the igniter. As such, the activation switch may be provided as a pin placed within the UAV 100 and projecting outside the body to be pulled by a user. The pin prevents electrical current from flowing to the igniter until the pin is removed, at which point the timer is started. At a predetermined interval, after the timer has started, the electrical circuit to the igniter is completed causing the engine to fire up and launch the rocket body 110.

In some embodiments, the ignition system further includes an angle-of-launch safety system that includes an accelerometer and/or magnetometer to determine the angle of the UAV 100. The accelerometer and/or magnetometer may or may not be the same as those used by the UAV 100 to provide additional UAV data as described above. In various embodiments, the accelerometer and/or magnetometer may be controlled by a dedicated processor or the computing device 124. In either case, software on the processor/computing device operates to verify that the angle of launch is within a safety limit before activating the pyrotechnic igniter. In some embodiments, audio or visual indicators are provided to enable a user to find an optimum launch angle. For example, a series of audible beeps or flashing indicators such as LEDs, with varying frequency depending on how far/close the launch angle is to the optimum angle, are provided to enable intuitive finding of the optimum angle. The optimum launch angle may be determined by pre-programmed or calculated trajectory angles for launch that depend on the desired location and altitude of the UAV 100 for capturing aerial images of a particular area of interest. In some embodiments, standard two degree of freedom trajectory models are used in calculating the optimum launch angles. However, it will be understood that the final launch angle used in a given situation will depend on how far down range the user wishes to send the UAV 100.

In some embodiments, the UAV 100 carries a self-destruct system, able to render the UAV 100 useless to undesirable users and prevent them from gathering information captured by the UAV 100. The self destruct system is arranged to be activated at a pre-determined time after ground impact of the payload section, determined by an onboard accelerometer. A backup timer, initiated at launch and set for a predetermined time interval, may also be used in case ground impact is not detected. The self-destruct system may be a software erase system commanding all data and programming carried by the payload section to be erased upon activation of the system and/or a mechanical hardware destruction system including a pyrotechnic device, for instance, arranged to physically damage hardware carried by the payload section upon activation of the system. In any such embodiment, the self-destruct system may be controlled by software associated with the computing device 124 or other dedicated processor on board the UAV 100. In some embodiments, a hardware destruct system will include an electronic switch and fuse. The electronic switch shorts the main power to the system, resulting in all fuses being blow rendering the hardware useless. In such embodiments, it is contemplated that the fuses may be provided in the form of small surface mount items.

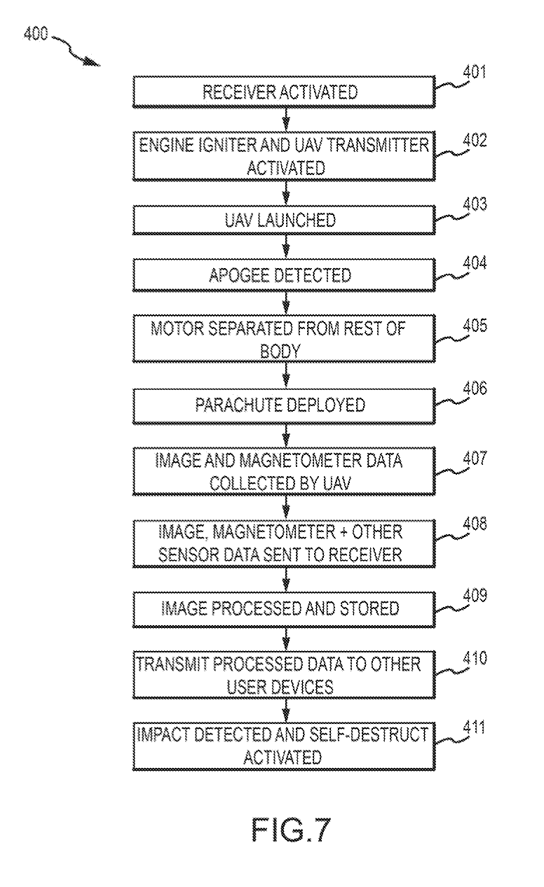

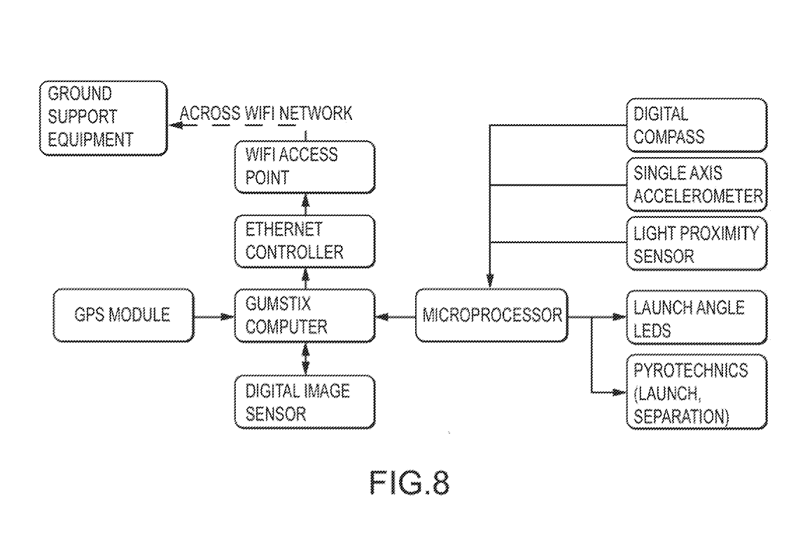

With reference to FIG. 7, one method of operating the UAV 100 begins with activation of the ground station receiving unit, which seeks a signal from the UAV 100 and alerts the user once data is received (step 401). The user then pulls the mechanical pin activating a switch that enables power to be sent to the rocket engine igniter and starting a timer. The UAV transmitter 130 is activated (step 402). After a predetermined time, provided the angle of the UAV 100 is within safety limits (if using the accelerometer), the engine igniter is fired, launching the UAV 100 (step 403). Launch is detected by an accelerometer on the UAV 100 and a mission timer is started. Apogee is detected (step 404) by the accelerometer, triggering the parachute deployment system. After a predetermined time or altitude, the propulsion section 112 is separated from the rest of the rocket body 110 (step 405). The parachute 128 is then deployed (step 406), stabilizing the payload section 118 and allowing it to descend at a nominal velocity. The image capturing device 122 takes images of the region underneath the payload section 118 at pre-defined intervals (e.g. 1 per second) and the magnetometer takes readings indicative of a compass heading simultaneously (step 407). Images with attached relevant sensor data are transmitted to the remote ground receiver unit 300 (step 408). Images and sensor data are processed and stored on the remote ground receiver unit 300 (step 409). The images and sensor data are available for viewing and transmission to other user devices as required (410). Magnetometer data is used to determine the orientation of the image capture device 122 of the UAV 100 with respect to magnetic north and reference compass bearings to each image. If applicable, other relevant sensor data are processed to provide more information to the image, such as distance and/or latitude and longitude coordinates. The accelerometer detects impact at which point the self-destruct mechanism is activated (step 411). A time limit is used for this activation as back-up. FIG. 8 depicts a schematic of one embodiment of the electronics and avionics equipment associated with the UAV 100, which takes the UAV 100 through the aforementioned steps 401 through 411.

In many embodiments, the UAV 100 deploys in a matter of seconds and imagery can be obtained in under 20-30 seconds after launch. The rocket body 110 and payload section 118 will descend slowly under the parachute 128 giving the operator and command network continuously captured high-resolution images of the ground throughout its descent. The descent and ascent is unguided and not actively stabilized in the embodiment described above; however, the UAV 100 in alternative embodiments may use stabilization or other propulsion systems to control the attitude, stability and position of the UAV 100. For instance, passive or active mechanical aerodynamic methods could be used to achieve this stabilization.

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein arc to be understood to encompass and provide support for claims that recite any and all sub ranges or any and all individual values subsumed therein. For example, a stated range of 1 to 10 should be considered to include and provide support for claims that recite any and all sub ranges or individual values that are between and/or inclusive of the minimum value of 1 and the maximum value of 10; that is, all sub ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An unmanned aerial vehicle comprising:
a rocket body including a propulsion section and a payload section;
a plurality of stabilizing fins extending from a rearward portion of the rocket body;
a parachute having a stored position within the rocket body and a deployed position substantially removed from within the rocket body; the parachute being coupled with the payload section;
an image capture device positioned in the payload section;
a magnetometer positioned in the payload section capable of providing a compass reference; and
a radio transmitter positioned in the payload section capable of transmitting image and magnetometer data to a remote receiver.

2. The unmanned aerial vehicle of claim 1 wherein the payload section is separable from the propulsion section during flight.

3. The unmanned aerial vehicle of claim 1 wherein the image capture device is located at a nosecone portion of the payload section; the image capture device being positioned with respect to the nosecone that enables the image capture device to obtain image data of an environment around the unmanned aerial system during a descent of the payload section.

4. The unmanned aerial vehicle of claim 3 wherein the nosecone is comprised of an optically clear material adjacent to the image capture device such that the image capture device may obtain the image data through the nosecone while the payload section descends.

5. The unmanned aerial vehicle of claim 1 wherein the image capture device is provided to selectively take still images or video.

6. The unmanned aerial vehicle of claim 1 wherein the image capture device comprises infrared sensors.

7. The unmanned aerial vehicle of claim 1 wherein the image capture device comprises synthetic aperture radar.

8. The unmanned aerial vehicle of claim 1 wherein the payload section further contains equipment for providing data indicative of latitude and longitude, altitude and attitude of the vehicle.

9. The unmanned aerial vehicle of claim 8 wherein the equipment is any combination of a GPS antenna and receiver, one or more barometers, and one or more inertial measurement units.

10. The unmanned aerial vehicle of claim 1 wherein the fins are retractable towards the body for storing the vehicle.

11. The unmanned aerial vehicle of claim 1 further comprising a self-destruct system that destroys a portion of the unmanned aerial vehicle after a pre-determined period of time after the payload section completes a descent portion of a flight.

12. The unmanned aerial vehicle of claim 11 wherein the payload section further includes a computing device with at least one processor and software operative on the processor to control the image capture device, magnetometer, and radio transmitter; the self-destruct system including a software erase system arranged to erase software and data within the payload section on activation of the system.

13. The unmanned aerial vehicle of claim 11 wherein the self-destruct system includes a hardware destruction system including a pyrotechnic device arranged to physically damage hardware carried by the payload section on activation of the system.

14. An unmanned aerial system comprising:
a UAV, having at least: (i) a rocket body that includes a rocket motor and a payload section; (ii) a parachute within the rocket body and coupled to the payload section in a manner that permits regulating a descent of the payload section; (iii) an image capture device in the payload section; (iv) a magnetometer in the payload section capable of providing a compass reference; and (v) a radio transmitter in the payload section;
a launch unit that is shaped to receive the UAV;
an ignition system coupled with the rocket motor; and
a ground station unit having a receiver that is tuned to receive data from the radio transmitter of the UAV.

15. The system of claim 14, wherein:
the launch unit includes a handheld launch tube.

17. The system of claim 15, wherein:
the handheld launch tube has a length of less than 24 inches and a diameter of less than or equal to 2 inches.

18. The system of claim 14, wherein:
the ground station unit is a portable ground unit and comprises an onboard processor for manipulating and processing of images and data received from the UAV.

19. The system of claim 14, wherein:
one or more processors in the UAV includes software operative to receive data from the magnetometer and overlay a compass bearing over an image received from the image capture device.

21. The system of claim 14, wherein:
one or more processors in the ground station unit includes software operative to receive data from the magnetometer and overlay a compass bearing over an image received from the image capture device.

22. The system of claim 14, wherein:
the ignition system comprises:
a processor that includes software operative to control operation of aspects of the system,
a launch timer electrically coupled with an activation switch; and
a pyrotechnic igniter coupled with the rocket motor; the pyrotechnic igniter being electrically coupled with the processor, which further includes software operative to activate the rocket motor after initiation of the launch timer.

23. The system of claim 22, wherein:
the activation switch is a pin within the UAV and projecting outside said rocket body; the pin being selectively movable by a user from a safe position to a launch position; the pin preventing electrical current from flowing to the igniter in the safe position.

24. The system of claim 14, wherein:
the ignition system includes at least one of an accelerometer or magnetometer;
the processor including software that is operative to receive data from the accelerometer or magnetometer and determine the angular position of the UAV with respect to a horizontal reference point;
the software on the processor being further operative to verify that the angular position of the rocket within a user definable safety limit before activating a pyrotechnic igniter coupled with the rocket motor.

25. The system of claim 24, wherein:
the processor further includes software operative to activate an indicator when the UAV is oriented at an optimum launch angle.

26. The system of claim 25, wherein:
the optimum launch angle is determined by pre-programmed or calculated trajectory angles for launch that depend on the desired location and altitude of the UAV for capturing particular aerial images.

27. A method for providing frames of reference for aerial reconnaissance images comprising:
receiving image data indicative of one or more images captured from an unmanned aerial vehicle having an image capture device and a magnetometer associated with the image capture device;
receiving magnetometer data associated with the images, and
referencing compass bearings to each image using the magnetometer data to determine the orientation of the image capture device of the UAV with respect to magnetic north.

28. The method of claim 27 further comprising:
launching the UAV along an arial trajectory from a point adjacent a ground level, prior to receiving the image data.

29. The method of claim 27 further comprising:
referencing distance in an image using pre-determined scales, dependent on altitude data.

30. The method of claim 29 further comprising:
referencing GPS co-ordinates to one or more points in an image.
